(19) United States
(12) Patent Application Publication
(10) Pub. No.: US 2006/0156330 A1
(43) Pub. Date: Jul. 13, 2006

(54) Intelligent interactive multimedia

(76) Inventor: Fu-Sheng Chiu, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/030,113

(22) Filed: Jan. 7, 2005

(51) Int. Cl. H04N 7/16; H04H 9/00; H04N 7/173

(52) U.S. Cl. 725/24; 725/135; 725/13

(57) ABSTRACT

An intelligent interactive multimedia system that provides a wide variety of multimedia content and services to a plurality of users utilizing various platforms. A plurality of channels is provided to users. Users or a group of users can participate in interactive multimedia sessions and communicate by text messaging, audio, or video signals in real time. Numerous interactive tools such as application sharing, synchronized internet browsing allowing users to browse the network together, file distribution and sharing, voting and polling, session recording, shared whiteboard, and chat room are provided. An advertising and purchasing module allow products to be advertised and purchased.

### BACKGROUND OF THE INVENTION

1. Field of the Invention

The present invention relates to multimedia. More specifically, the present invention discloses an intelligent and interactive multimedia system in which a plurality of users are able to interact with multimedia content.

2. Description of the Prior Art

Traditional television broadcasting is achieved by transmitting the television signal via satellite or cable to a number of viewers. The television content is pre-scheduled and pre-recorded. While this method is suitable for certain types of content, the inflexible nature of this system is a disadvantage for modern content delivery. As a result, viewer satisfaction is lower than desired.

For example, a television network may decide to broadcast a movie at a particular time and date. In order for a user to view the movie, they must be available and watching the channel at the time of broadcast. This is inconvenient for many viewers and results in fewer people watching the movie. Furthermore, fewer viewers results in decreased profit for broadcasters due to lowered ad revenues.

Some users attempt to improve on these disadvantages by recording the broadcast content so that they can view it at a convenient time. However, this does not solve the problem of selection or choice of content. Viewers are still limited to content chosen by the broadcaster. In addition, it is inconvenient and troublesome for users to set up a recording schedule. Therefore, it is common for record timing errors to occur or for users to decide it isn't worth the effort. Either way, the number of viewers is far below optimal.

Additionally, in traditional broadcasting users simply view the content, which is a passive experience without interaction. This lack of interaction quickly leads to boredom and lowered viewer satisfaction.

Therefore, there is need for multimedia content for a plurality of users that allows the individual users to select the content and interact with other users and the content.

### SUMMARY OF THE INVENTION

To achieve these and other advantages and in order to overcome the disadvantages of the conventional method in accordance with the purpose of the invention as embodied and broadly described herein, the present invention provides intelligent interactive multimedia.

The present invention provides an intelligent interactive multimedia system that provides a wide variety of multimedia content and services to a plurality of users utilizing various platforms.

For example, users can utilize the Internet, satellite television, cable television, television equipped with set top boxes, telecom network, wireless, cellular phone, local area network, or other electronic equipment connected to other types of networks.

Additionally, the present invention allows users to not only enjoy the multimedia content, but also interact with the multimedia content, thereby increasing the participant's level of enjoyment and satisfaction. As a result users are more likely to participate more frequently and for longer periods of time.

The present invention supports streaming of multiple video and audio signals simultaneously on a single channel. For example, 8 video signal and 8 audio signals can be provided on a single channel. As a result, a single display or window can allow users to conveniently interact with these multiple multimedia signals. Since the present invention provides real-time or near real-time streaming, content providers or producers can utilize interactive applications. For example, when a content producer provides multimedia content, users can interact with the multimedia content and with other users in real-time.

Additionally, the present invention provides a plurality of channels for users to select from. For example, channels with specific content or themes such as movies, education, meetings, conferences, and concerts can be provided to users. Channels can be grouped by theme or area of interest.

Users or a group of users can participate in interactive multimedia sessions and communicate by text messaging, audio, or video signals in real time or near real time.

Furthermore, numerous interactions such as application sharing, synchronized internet browsing, file distribution and sharing, voting and polling, session recording, shared whiteboard, and chat room are provided.

These and other objectives of the present invention will become obvious to those of ordinary skill in the art after reading the following detailed description of preferred embodiments.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a diagram illustrating an infrastructure of an interactive multimedia system according to an embodiment of the present invention; and

FIG. 2A and FIG. 2B are block diagrams illustrating an interactive multimedia system according to an embodiment of the present invention.

### DESCRIPTION OF THE PREFERRED EMBODIMENTS

Reference will now be made in detail to the preferred embodiments of the present invention, examples of which are illustrated in the accompanying drawings. Wherever possible, the same reference numbers are used in the drawings and the description to refer to the same or like parts.

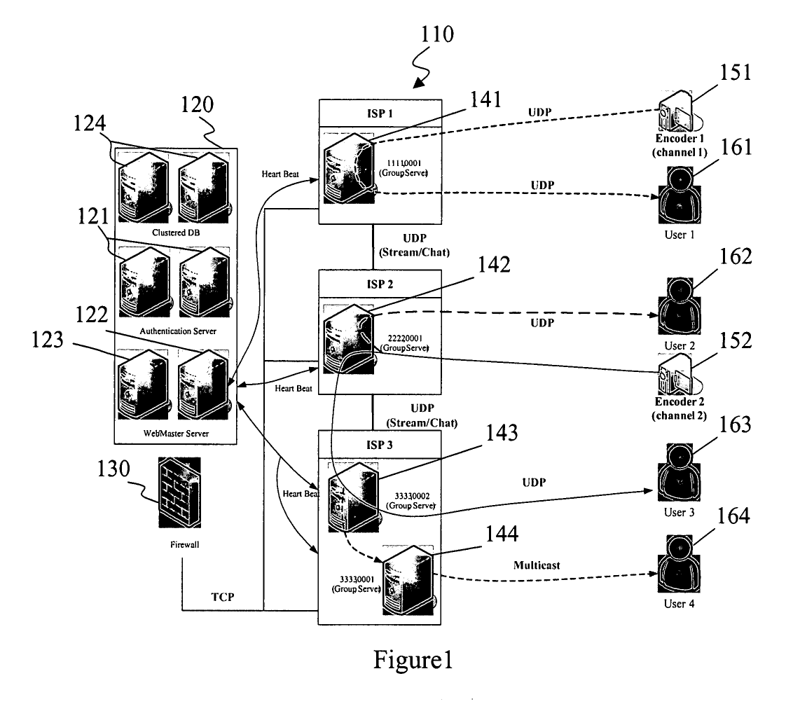

Refer to FIG. 1, which is a diagram illustrating the infrastructure of an interactive multimedia system according to an embodiment of the present invention.

The infrastructure of the interactive multimedia system 110 of the present invention basically comprises a core server 120 or core servers, a plurality of streaming server 141, 142, 143, 144, and at least one encoder 151, 152. Multimedia content is streamed from the encoder 151 to a user 161 via a streaming server 241.

The core servers 120 comprise an authentication server 121, a master server 122, a web server 123, and a database 124. The authentication server 121 is for checking authenticity of users. Users must pass the authenticity check before they can connect to a streaming server. The master server 122 is for redirecting users to a specific streaming server based on the policy defined in the master server 122. The policy determines which server streams the multimedia content to users. The policy can consider an IP range, user information, user account, company name, channel, etc. For example, the policy can be set so that a user's IP indicates the user's location, and an appropriate streaming server located near the user's location can be selected.

The web server 123 provides program information, for example like television program information, to assist users in selecting a channel or program. The program information can list program title, producer, synopsis, time, date, popularity, or other information.

The database 124 stores a variety of data such as user information, account information, policies, web information, etc.

The core server 120 can comprise a single server or multiple servers. For example, the authentication server 121, master server 122, web server 123, and database 124 can be realized in a single server. Alternatively, each can be a separate server or a combination of servers.

A firewall 130 separates the core servers 120 and the streaming servers 141, 142, 143, 144. This increases the level of protection for the cores servers 120 and reduces the likelihood of attack by hackers.

The streaming servers are a plurality of servers 141, 142, 143, 144 arranged to stream the multimedia content to and from users 161, 162, 163, 164. By adding more streaming servers, the system can be easily scaled to meet the needs of the number of concurrent users. In this way, the load is balanced between the servers and due to the plurality of streaming servers, the servers have high availability.

In order to determine which streaming servers 141, 142, 143, 144 are available or on-line, the master server 122 periodically sends heart beat signals to each streaming server 141, 142, 143, 144. The heart beat signals are, for example, TCP packets. This allows the master server 122 to maintain a list of active servers. Therefore, if a streaming server is down or brought off line for maintenance, the master server 122 will redirect users to other streaming servers based on the defined policy and list of active servers.

Additionally, the channel or channels can be streamed via multicast protocol in order to save bandwidth.

The encoder or encoders 151, 152 encode the multimedia content. They also make real time streaming possible and provide various bit rates and resolutions. According to the capabilities or environment of the network, channels can be encoded as low as 56 Kbps for dial-up links or up to broadband speed, for example 1.5 Mbps or higher, to provide better quality. Similarly, the resolution can be selected. For example, the resolution can be set to 160×120, 176×144, 320×240, 352×288, 640×480, or higher. Additionally, the frame rate can be adjusted according to the available bandwidth with a higher frame rate requiring more bandwidth. The frame rate can be set to, for example, as low as 1 frame per second or as high as 30 frames per second. Furthermore, the encoders 251, 252 utilize an optimized compression codec that allows real-time or near real-time streaming without the need for buffering. This allows users or broadcasters to interact with the streaming multimedia content in real-time or near real-time.

Transmission control protocol (TCP) is used to connect the core servers 120 and the streaming servers 141, 142, 143, 144. TCP guarantees delivery of data and ensures that packets are delivered in the same order in which they were sent.

User datagram protocol (UDP) is used to provide a direct way to send and receive datagrams over the IP network between the encoders 151, 152, streaming servers 141, 142, 143, 144, and users.

Multicasting can be utilized to permit sending content to a select group or number of users. For example, streaming server 143 can comprise several servers 143 144 in order to multicast to users 163 and 164.

As an example of application of the intelligent interactive multimedia system of the present invention, the following scenario is provided.

A multimedia producer prepares multimedia content. The multimedia content can be pre-recorded or can be live. A multimedia provider creates or assembles the infrastructure required to distribute the multimedia content. The multimedia producer and the multimedia provider can be the same entity or different entities. The multimedia provider also prepares programming information regarding the multimedia content to assist users in making program or channel selection.

Once the system is established, users can register or sign up for the service. Their user and account information is stored in a database. After the user connects with the multimedia provider and enters their access information, their authenticity is verified. Then the user is able to access the programming information or guide in order to select a channel. When the user has selected the desired channel, the appropriate streaming server is selected and the multimedia content begins streaming to the user.

Since the multimedia content is streamed in real-time or near real-time, the user is able to interact with the content. There are numerous ways in which the user can perform this interaction. For example, if the user is connected via the Internet, the user can simply type text into a field in the chat portion of the interface. Depending upon the channel, provider, policy, or producer, the text can automatically show up or can be selectively chosen to show up on the multi-section display. This allows other users to see the sender's comments. In this way, all users of the channel can communicate between each other or with the producer in real-time. Additionally, this allows the content producer to adapt their programming according to user's feedback or discussion. For example, if the multimedia content is a movie, users can may comments or discuss aspects of the movie as it is showing. In another example, if the content is an educational program such as a class on a particular subject, the users can participate in the lecture as students by asking or answering questions.

In addition to text, the system of the present invention also allows users to provide video and audio signals with the addition of a microphone and web camera. In this way, the users can act as partial content producers. As in the educational program example above, video of the instructor would appear in one portion of the display and video of individual students can be displayed in other portions of the display. The multi-section display could simultaneously comprise, for example, video from a plurality of individual students as well video of the instructor. Similarly, audio from different users can be heard in addition to the instructors. This allows the virtual environment of the channel to be as close to an in-person experience as possible.

Users can also achieve similar results by using a television equipped with a set top box. Alternatively, users can utilize a cellular telephone, for example a 3G handset, to interact. Depending upon the user's equipment the interaction can comprise short message service (SMS) messages, multimedia message service (MMS) messages, still photographs, video, and audio. Furthermore, users can enjoy the audio portion of the multimedia content and interact audibly with the content by using a traditional telephone.

The intelligent interactive multimedia supports simultaneous streaming of multiple video and audio signals on a single channel. Real-time or near real-time streaming across the network is provided due to the enhanced compression technology. This allows content producers or content providers to provide interactive applications and content to users.

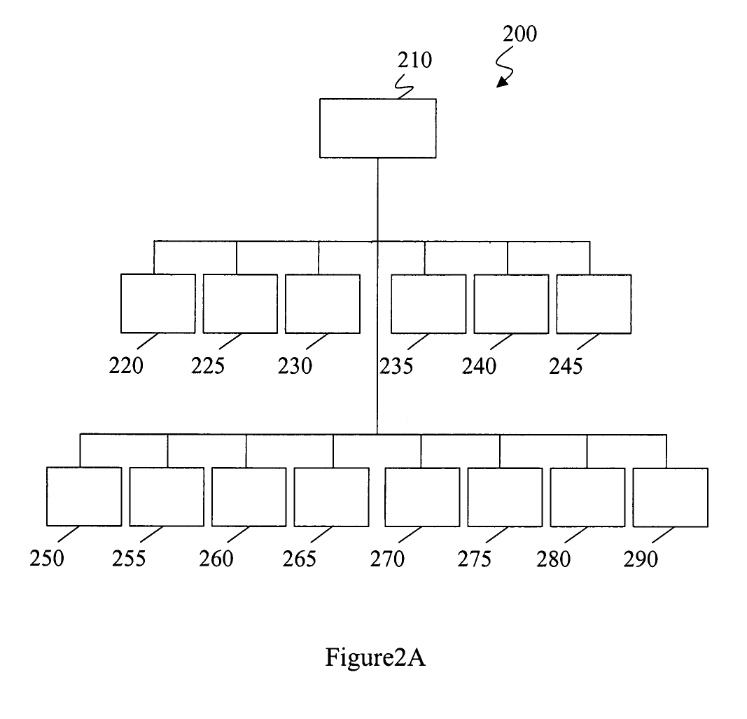

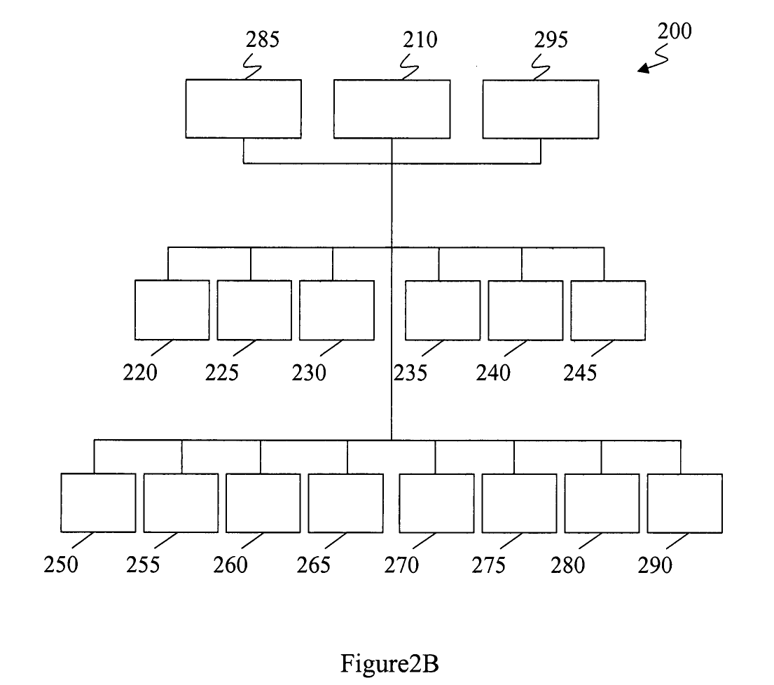

Refer to FIGS. 2A and 2B, which are block diagrams illustrating various interactive modules of interactive multimedia according to an embodiment of the present invention.

The interactive multimedia 200 of the present invention comprises a number of modules that provide various interactions such as messaging, application sharing, synchronized internet browsing, file distribution and sharing, voting and polling, session recording, shared whiteboard, and chat room.

The present invention allows application sharing between users by providing an application sharing module 220. All Microsoft Windows programs can be shared between the host and users. For example, a host can execute and utilize a program while other users observe the actions, progress, and results. This is highly effective in demonstrating or training sessions where a host can teach or instruct a plurality of users at one time without being constrained to a single location.

Additionally, the host is able to pass application control to other users, which enables seamless communication and achieves real-time information exchange. For example, once the host has demonstrated a technique, the host can pass control to a user, student, or trainee and have them reproduce the actions or result. Furthermore, this allows users to utilize the program without requiring the application to be installed on the user's device or computer. This is useful for demonstrating products to potential buyers before they make a purchase.

The system also provides a synchronization module 225 for allowing synchronization control over an Internet or network browser. The host can issue a link command and all users participating in the channel or session can browse through a webpage or website in sync.

For example, a marketing representative could introduce a variety of products displayed on the representative's company website to a number of prospective customers. Since the representative and the users are all synchronized they will be looking at the same items at the same time. Additionally, since users are able to interact, the users can ask questions via text or audio and the representative can answer via text or audio.

Also, this control can be passed to a user so that they can select a web site for all users to visit. In this way the synchronized browser can act as a tour guide and lead other users on a virtual tour of a website or the Internet all while allowing users to interact with each other.

File distribution is provided by a file distribution module 230 so that the host and users can deliver or exchange materials, multimedia, data, or files with participants in the channel or session. Individual users all have the right to accept or deny delivery of the exchanged data. The system can also emulate a pier to pier network in which users can share files or data between each other. In addition, users can communicate and interact with other users in order to recommend or discuss the files or data.

For example, utilizing the file distribution module 230 a presenter can easily send additional information or the contents of the presentation to participants during the presentation.

A voting or polling module 235 is provided so that the host or users can create a poll and the participants can vote. The poll can be created manually or automatically from a questionnaire of file. Once voting begins, the system can provide the results to only the host or show the results to everyone. Additionally, the results can be updated and displayed in real time during the voting, or can be tallied and displayed after voting is over.

Also, this voting module 235 can also be used as question and answer system. For example, on an educational channel the host or instructor can pose a question and each user or student can respond with their answer. The answers can be formulated in multiple choice, essay, fill in the blank, etc. formats. The percentage or number of users selecting each answer can be displayed during the answering or after everyone has answered. The user names of the participants selecting the correct response can also be displayed if desired.

Additionally, the voting or answer history can be kept for individual participants. For example, a series of questions can be posed as a test by the instructor and the test results for individual users can be obtained. Similarly in a voting application, the voting history or behaviour can be recorded for future application or review.

The present invention also provides a shared whiteboard module 240 for allowing users and hosts to draw, write, and paste pictures on a whiteboard. Multiple users can interact on the white board at the same time. The host has the privilege to allow or deny permission to use the white board to certain users on a group or individual basis.

The shared whiteboard allows a group of users to quickly interact and exchange ideas or brainstorm. For example, a number of employees in a corporation can view a proposed design and each person can make revisions or changes to the drawing and all participants will see this in real time.

A chat module 245 is provided for allowing users to use a chat room or chat area to communicate with other online users. The chat area can be a separate tabbed page or can be displayed on the same page as other interactive tools. The chat area can be separated into different areas or can be arranged as a single area for a channel. For example, on an educational channel for engineering, the chat area can be regarding all engineering or split into areas depending on discipline, i.e. mechanical, electrical, civil, etc.

Similar to the other interactive tools, the right to use the chat area can be selectively given or denied to individual users or groups of users. For example, if a particular user is being disruptive, their right to use the chat area can be revoked or suspended temporarily, permanently, or indefinitely.

A messaging module 250 is provided for allowing users to communicate directly with a particular user without all other users observing the communication. For example, user A and user B can send text messages back and forth to each other without the other users being aware of or privilege to their conversation. However, the host has the ability to monitor the messaging if desired.

It should be noted that the chat module 245 and messaging module 250 can be the same module or separate modules.

The present invention also provides a recording module 255. If given the privilege by the host, users can record the progress of a channel or meeting. Not only is the video recorded, but also information exchanged in chat room areas, messaging, voting, synchronized browsing, and whiteboard can be recorded. The host also has the ability to fully record the interaction or selectively record sections of the session. Once recorded, the user or host has the ability to replay the entire interaction at a later date. This is particularly useful for types of interactions such as meetings, conferences, lectures, training, etc.

For commercial content producers or providers an advertising module 260 is provided. Content producers or providers can periodically or continuously display advertising or notices. The revenue earned by this advertising can be used to offset the cost of producing the interactive multimedia content.

Additionally, the voting module 235 and advertising module 260 can work together so that users can vote in regards to the advertised product or products. Alternatively, advertisements can be selected based on voting results. For example, if a poll asks for a user's favorite hobby and the user votes for sports, an advertisement regarding sports can be displayed.

To assist users in remembering times or schedules of live or pre-recorded content, a scheduler module 265 is provided. The scheduler allows users to establish a recording schedule for future sessions or occurrences. For example, if a live concert will be broadcast at a certain time or date, the user can enter the information in the scheduler and the concert will be recorded regardless if the user is present at the broadcast time.

Additionally, the scheduler can act as a timer or alarm which will give the user a notice or reminder when a session is approaching. For example, if a network meeting session will occur on a certain date, the scheduler will give the user notices at selected intervals to prepare the user for the session.

A digital rights management module 270 is provided in order to protect the multimedia content. If content producers desire to protect their content against copying or recording, the content can be encrypted or protected. In this way, users can view the content a single time, or only in real time, or are unable to record the multimedia stream. Additionally, the digital rights can prevent unauthorized users from viewing the content or allow users to pay for the rights to view or save the content.

A purchase module 275 allows users to quickly and easily purchase multimedia content or products presented on a channel. For example, a user can purchase a movie or concert video while watching or after watching the content. Similarly, products shown, introduced, or advertised on a channel can easily be purchased by the user. If desired, the purchasing history or behaviour of individual or groups of users can be obtained. Users are able to enable or disable this function. A beneficial aspect to this function is that users can receive recommendations of like-minded users based on their purchasing history or pattern. For example, if user A purchases a Jazz music CD by artist B, the purchasing history of other users that also purchased artist B's CD can be used to recommend a similar artist C to user A.

The present invention also provides an interface module 210 for displaying the interactive tools, session, channel, and other interface options such as menus. The interface module 210 provides a multi-paged tabbed interface. Pages on the interface can be easily switched between by selecting the desired tab. This also works for creating a new page, for example, a clean whiteboard. The tabbed interface can also be synchronized or locked so that users see the same page. This control can be set or unlocked by the host for other users or by individual users for themselves.

Content providers or producers can establish the layout of the interface or users can set up the layout themselves. Typically, producers will create the layout of the interface in order to produce a distinctive or useful layout. A default layout is provided for a standard interface.

A controller module 295 is provided for controlling the tools, applications, operations, coordination of the modules, data handling, etc. The controller module 295 and the interface module 210 can be the same module or separate modules.

A multimedia module 285 is provided for controlling the multimedia content such as movies, video, presentations, or music. If the multimedia module 285 is realized in a separate module, the specialized nature of the module enhances the graphics or multimedia capabilities and performance. Alternatively, the multimedia module 285 can be combined with the controller module 295 and/or interface module 210 as a single module.

A channel guide module 280 is provided for displaying a program or channel guide to allow users to select between channels, obtain channel information, scheduling, etc. The channel guide module 280 works together with the scheduler module 265 so that users can easily schedule recording or notification of upcoming events. The channel guide can group and display channels by multimedia type, content, area, location, interest, popularity, date, etc. In this way, users can, for example, quickly find content in their area of interest or shortly upcoming events.

The present invention also provides a bulletin module 290 to allow hosts to send broadcast notices to users. The announcements or text can be scrolled horizontally, vertically, static, or displayed in other ways. This allows a host to send messages, for example, announcements, updates, or notices to all users or selected users. For example, on a sports channel, continuously updated scores can be displayed.

As an example of an application of the present invention, the following scenario is given. This scenario is for example only and can be modified in various ways, such as to type of content or sequence.

A multimedia producer, producer A, prepares a group of sports highlight videos. The videos can be encoded and stored on a server or a streaming server. The videos can also be encoded and streamed on the fly. A multimedia provider, provider B, has set up the infrastructure comprising the core servers, streaming servers, network, and encoders. A user, user C signs up for the service. When the user desires to view the multimedia content, user C logs into the system and enters their user information. The authentication server verifies user C's information. Once verified, user C is connected to the web server in order to view program information stored in the database. The available programming can be formatted by the master server, list of available servers, policy, IP or other criteria. User C has an interest in sports and chooses to view the content provided by producer A. After selecting the channel and video, the streaming server begins streaming the video to user C.

In a more complex extension of the above, producer A also provides a sports forum. The forum is hosted by a coach. A number of users, user C, user D, user E, and user F, desire to participate in the forum. Each user has a webcam and microphone connected to their computer. Once the forum session begins, the audio and video signals from each of the users is encoded and streamed to each of the other users as well as to the coach's display. Additionally, the video is streamed to each of the users. All of these video signals are displayed on a single display in multiple sections or areas of the screen. The layout of the screen can be selected by the producer or personalized by individual users. Additionally, the coach can control which audio signals are heard by individual users. For example, if user C wants to ask a question, the host can let user C's audio be heard.

Furthermore, while the video is streaming, each user can communicate with the host and other users via text messaging. For example, the users and the host can make comments about a particular play or discuss the video as it is showing.

During the entire session, the master server continues to maintain an active server list by sending heart beat packets to the streaming servers. In this way, if any of the streaming servers goes down, the user is automatically redirected to another streaming server.

For example, if user C is in the United States, and the chosen streaming server that is currently being used, crashes. The master server automatically redirects user C to another active server, possibly based on user C's policy or IP address. In this example, the master server selects an active server located in user A's hometown.

Obviously, many variations can be made to the above example. For example, the content, number of users, providers, content location, etc. can be changed or adapted according to requirements.

It will be apparent to those skilled in the art that various modifications and variations can be made to the present invention without departing from the scope or spirit of the invention. In view of the foregoing, it is intended that the present invention cover modifications and variations of this invention provided they fall within the scope of the invention and its equivalent.

What is claimed is:

1. An interactive multimedia system comprising:
a plurality of multimedia content;
an interactive guide for assisting users in selecting multimedia content;
a file sharing module for providing file and data sharing between users;
an application sharing module for providing application sharing between users;
a synchronized network browsing module for allowing users to browse a network together;
a voting module for allowing users to vote;
a shared whiteboard on which users can draw, type, or paste images;
a chat room for allowing users to communicate with other users;
a meeting module for allowing users to participate in a group meeting session;
a recording module for allowing users to record content of the session;
a multi-paged tabbed interface for allowing users to switch between pages of the session; and
an advertising module for providing promotional material to users;

2. The interactive multimedia system of claim 1, wherein the multimedia content comprises movies, videos, audio, music, games, presentations, or a combination of these.

3. The interactive multimedia system of claim 1, wherein the multimedia content is streamed in real time or near real time.

4. The interactive multimedia system of claim 1, wherein a plurality of multimedia is streamed in one signal.

5. The interactive multimedia system of claim 1, wherein users can accept or refuse delivery of the shared file or data.

6. The interactive multimedia system of claim 1, wherein the voting results are automatically tallied.

7. The interactive multimedia system of claim 1, wherein the voting results are selectively shared with users.

8. The interactive multimedia system of claim 1, wherein the users communicate in the chat room via text messages.

9. The interactive multimedia system of claim 1, wherein right of individual users to utilize the whiteboard, chat room, or voting is selectively given or denied.

10. An interactive multimedia system comprising:
an application sharing module for allowing application sharing between users;
a synchronization module for allowing synchronization control over an Internet browser;
a file distribution module for allowing users to deliver or exchange materials, multimedia, data, or files with other users;
a voting module for allowing users to create a poll and vote;
a shared whiteboard module for allowing users to draw, write, and paste pictures on a shared whiteboard;
a chat module for allowing users to use a chat room to communicate with other online users
a messaging module for allowing users to privately communicate with other users;
a recording module for allowing users to record content;
a channel guide module for displaying an interactive guide to allow users to select between the multimedia content; and
an interface module for displaying interactive tools provided by the modules.

11. The interactive multimedia system of claim 10, further comprising:
an advertising module for allowing advertising to be displayed;
a scheduler module is provided to assist users in scheduling;
a digital rights management module for protecting the multimedia content;
a purchasing module for allowing users to purchase the multimedia content or products presented;
a multimedia module for controlling the multimedia content;
a bulletin module for allowing hosts to send broadcast notices to users;
a controller module for controlling the modules.

12. The interactive multimedia system of claim 10, wherein the multimedia content is streamed in real time or near real time.

13. An interactive multimedia system comprising:
an application sharing module for allowing application sharing between users;
a synchronization module for allowing synchronization control over an Internet browser;
a file distribution module for allowing users to deliver or exchange materials, multimedia, data, or files with other users;
a voting module for allowing users to create a poll and vote;
a shared whiteboard module for allowing users to draw, write, and paste pictures on a shared whiteboard;
a chat module for allowing users to use a chat room to communicate with other online users
a messaging module for allowing users to privately communicate with other users;
a recording module for allowing users to record content;
an advertising module for allowing advertising to be periodically or continuously displayed;
a scheduler module is provided to assist users in remembering times or schedules of live or pre-recorded content;
a digital rights management module for protecting the multimedia content;
a purchasing module for allowing users to purchase the multimedia content or products presented;
a channel guide module for displaying an interactive guide to allow users to select between the multimedia content;
a multimedia module for controlling the multimedia content;
a bulletin module for allowing hosts to send broadcast notices to users;
an interface module for displaying interactive tools provided by the modules; and
a controller module for controlling the modules.

14. The interactive multimedia system of claim 13, wherein the multimedia content comprises movies, videos, audio, music, games, presentations, or a combination of these.

15. The interactive multimedia system of claim 13, wherein the multimedia content is streamed in real time or near real time.

16. The interactive multimedia system of claim 13, wherein a plurality of multimedia is streamed in one signal.

17. The interactive multimedia system of claim 13, wherein users can accept or refuse delivery of the shared file or data.

18. The interactive multimedia system of claim 13, wherein voting results are automatically tallied.

19. The interactive multimedia system of claim 13, wherein the users communicate in the chat room via text messages.

20. The interactive multimedia system of claim 13, wherein right of individual users to utilize the whiteboard, chat room, or voting is selectively given or denied.
